(19) United States
(12) Patent Application Publication
(10) Pub. No.: US 2016/0143803 A1
(43) Pub. Date: May 26, 2016

(54) System and method for accompanying respiration

(71) Applicant: INNOVZEN, Rogues (FR)

(72) Inventor: Jean-Louis Portales, Ganges (FR)

(21) Appl. No.: 14/919,564

(22) Filed: Oct. 21, 2015

Related U.S. Application Data
(60) Provisional application No. 62/068,578, filed on Oct. 24, 2014.

(30) Foreign Application Priority Data
Oct. 22, 2014 (FR) 1460168

(51) Int. Cl. A61H 15/00

(52) U.S. Cl. CPC A61H 15/0078; A61H 2015/0014; A61H 2201/1623

(57) ABSTRACT

The invention relates to a system (1) for accompanying the respiration of a person, comprising:
a backrest (2) to receive the back of a person,
a pressure application device (3),
an actuator comprising a guiding assembly (40) configured to move the pressure application device (3) between the lower part and the upper part of the backrest (3) and a bending assembly (42), configured to move the pressure application device (3) with respect to the backrest (2) along an axis substantially perpendicular to a direction of movement of the guiding assembly (40) between an active configuration, in which the pressure application device is sunk into the backrest, and a passive configuration, in which the pressure application device is retracted.

### FIELD OF THE INVENTION

The invention relates to a system for accompanying and making rhythmical respiration aiming to provide wellbeing and relaxation to a person.

### TECHNOLOGICAL BACKGROUND

At present, people have a tendency to breath like they live: hastily. The respiration of people in a rush, often stressed, becomes short and shallow, at the limit of hyperventilation. In these conditions, air enters the lungs and exists rapidly therefrom, without ever having the time to reach the depths. Thousands of alveoli and capillaries are thus not sufficiently called upon. Knowing that oxygen goes from the alveoli to the blood and that carbon dioxide goes from the blood to the alveoli, too shallow respiration creates a lack of oxygen and reduces gaseous exchanges, thereby generating headaches, problems of concentration, dizzy spells, numbing in the hands and the feet, etc.

An armchair comprising an inclinable backrest and a roll system incorporated in the inclinable backrest is known, particularly from document US 2008/0266952. The roll system is configured to massage in a cyclic manner the back of a user seated in the armchair between a lower part and an upper part of the back of the user. During the massage, respiration instructions may be given to the user by an operator, particularly from pressure sensors making it possible to control the rhythm of breathing in and breathing out of the user, in order to synchronise his respiration on the movement of the rolls in his back. Tension gauges and pressure sensors are moreover implemented in order to control the rhythm of breathing in and breathing out of the user. In order to improve the effects of the armchair, light and/or sound impulses are moreover delivered during the massage.

This type of armchair thus makes it possible to attain a state of respiratory sinus arrhythmia. Nevertheless, such an armchair is complex due to the multiple sensors and transmitters present in said armchair and does not make it possible to take account of the morphology of the user or to accompany the respiratory mechanism in an overall manner and in all of its phases.

### SUMMARY OF THE INVENTION

An objective of the invention is thus to propose a system and a method for accompanying and making rhythmical respiration which is of simpler design and enables a user to breathe more deeply and in a more rhythmical manner than he does naturally in order to optimise beneficial and relaxing corporal oxygenation, while preferably taking account of the morphological data of the user.

To achieve this, the invention proposes a system for accompanying the respiration of a person, comprising:
a backrest configured to support the back of a person and comprising a lower part and an upper part intended to come opposite a lower part and an upper part, respectively, of the back of the person,
a pressure application device, configured to apply pressure against the backrest, and
an actuator comprising a guiding assembly configured to move the pressure application device between the lower part and the upper part of the backrest.

The actuator further comprises a bending assembly, configured to sink progressively into the backrest, during the movement of the guiding assembly between the lower part and the upper part of the backrest, the pressure application device following an axis substantially perpendicular to a direction of movement of the guiding assembly between a passive configuration, in which the pressure application device is retracted and an active configuration, in which the pressure application device is sunk into the backrest.

Certain preferred but non-limiting characteristics of the system for accompanying described above are the following:
the bending assembly comprises a jack comprising a cylinder and a rod, and a plate comprising a first zone and a second zone, the first zone being connected to the rod of the jack through a first pivot link and the second zone being connected to the cylinder of the jack through a second pivot link, the pressure application device being connected to the bending assembly through the plate,
the first zone and the second zone are separate and fixed with respect to each other,
the pressure application device is connected to the plate through a third pivot link, separate from the first and the second pivot link,
the guiding assembly comprises a carriage, translationally moveable along the backrest between the lower position and the upper position of said backrest, the bending assembly being fixed onto said carriage,
the pressure application device comprises at least two coaxial rollers configured to apply pressure on either side of the vertebral column of the person,
the system for accompanying further comprises a scanning device configured to determine a maximum travel of the guiding assembly between the lower part and the upper part of the backrest,
the system for accompanying further comprises a tipping device, configured to rock the system for accompanying as a function of the position of the guiding assembly, and
the system for accompanying further comprises a control unit configured to communicate instructions to the person as a function of the position of the guiding assembly, said control unit being able to comprise a telephone, a tablet or a central unit connected to a screen.

According to a second aspect, the invention also proposes a method for accompanying the respiration of a person by means of a system for accompanying as described above, comprising the following steps:
moving the guiding assembly in order to move the pressure application device between the lower part and the upper part of the backrest and,
simultaneously, progressively moving the bending assembly along an axis substantially perpendicular to a direction of movement of the guiding assembly between a passive configuration, in which the pressure application device is retracted and an active configuration, in which the pressure application device is sunk into the backrest.

Certain preferred but non-limiting characteristics of the method for accompanying respiration described above are the following:
the pressure application device is brought progressively into passive configuration when the guiding assembly is moved from the upper part in the direction of the lower part of the backrest and is brought into active configuration when the guiding assembly is moved from the lower part in the direction of the upper part of the backrest,
in active configuration, the pressure application device is sunk progressively into the backrest from the lower part to the upper part,
the sinking in of the pressure application device is linear,
the sinking in of the pressure application device is variable as a function of the position of the pressure application device, the pressure application device being sunk more into the backrest near to the upper part of said backrest than near to its lower part in order to improve the curvature of the back of the person,
the method for accompanying further comprises a step during which instructions are communicated to the person in order to synchronise the respiration of said person with the movement of the pressure application device, and
the method for accompanying further comprises the rocking of the system for accompanying as a function of the movement of the guiding assembly.

### BRIEF DESCRIPTION OF THE DRAWINGS

Other characteristics, aims and advantages of the present invention will become clearer on reading the detailed description that is given hereafter, and with regard to the appended drawings given as non-limiting examples and in which:

FIG. 1 is a schematic profile view of an example of embodiment of a system for accompanying respiration according to the invention,

FIG. 2 illustrates examples of trajectories of the pressure application device of the system for accompanying of FIG. 1,

FIG. 3 is a perspective view of the actuator of the system for accompanying of FIG. 1,

FIG. 4 is a profile view of the actuator of FIG. 3 in passive configuration,

FIG. 5 is a profile view of the actuator of FIG. 3, in active configuration,

FIG. 6a is a schematic profile view of the example of embodiment of claim 1, the system for accompanying respiration being in low position,

FIG. 6b is a schematic profile view of the example of embodiment of claim 1, the system for accompanying respiration being in high position,

FIG. 7 illustrates an example of trajectory of the scanning device during the determination of the upper position,

FIG. 8 is a schematic profile view of the example of embodiment of claim 1, the system for accompanying respiration being in low position and in active configuration, and

FIG. 9 is a flow diagram illustrating different steps of an example of embodiment of a method for accompanying according to the invention.

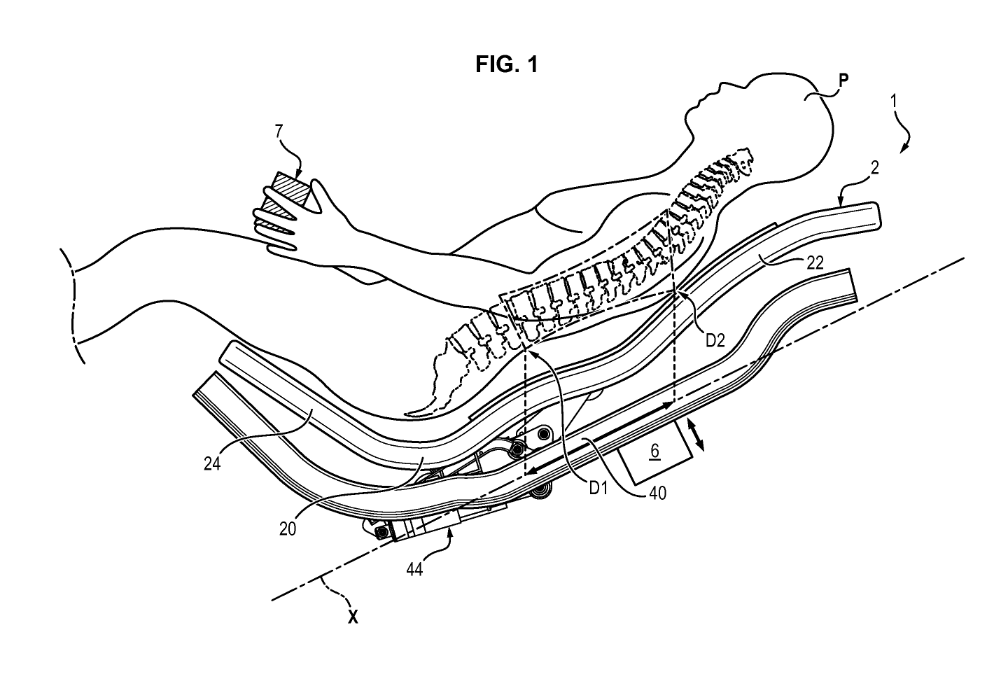

### DETAILED DESCRIPTION OF AN EMBODIMENT

A system 1 and a method S for accompanying respiration according to the invention will now be described in relation with the appended figures.

A system 1 for accompanying and making rhythmical respiration comprises:
a backrest 2 configured to support the upper extremities of a person P, in particular his back, and comprising a lower part 20 and an upper part 22 intended to come opposite a lower part and an upper part, respectively, of the back of the person P,
a pressure application device 3, configured to apply pressure against the backrest 2, and
an actuator comprising a guiding assembly 40 configured to move the pressure application device 3 between the lower part 20 and the upper part 22 of the backrest 2 and a bending assembly 42, configured to sink progressively into the backrest 2, during the movement of the guiding assembly 40 between the lower part and the upper part of the backrest 2, the pressure application device 3 following an axis substantially perpendicular to a direction of movement X of the guiding assembly 40 between a passive configuration, in which the pressure application device 3 is retracted and an active configuration (see FIG. 8), in which the pressure application device 3 is sunk into the backrest 2.

The system 1 thus makes it possible to move the pressure application device 3 so as to confer to the back of the person P a curvature making it possible to open his rib cage and to improve his oxygenation. The system makes it possible in fact to stress the body from the abdomen up to the shoulders of the person P, while concentrating more particularly on his rib cage, the centre of the respiratory mechanism.

In order to improve the relaxation of the person P, instructions for breathing in and breathing out may be communicated to him in order to synchronise his respiration with the movement of the pressure application device 3. These instructions may be given just as well orally by an operator as by a control unit 7.

Knowing that the heart is permanently accelerating and decelerating, one of the rare reflex activities where conscious control is possible is respiration. When the person adopts a voluntary and controlled respiration with the aid of the system of the invention, his respiration becomes full and regular. His heart can thus become synchronised with his respiration and the fluctuation of the cardiac frequency (cardiac variability) of the person becomes periodic and regular. This is what is known as cardiac coherence. For example, the system 1 may propose a respiration rhythm of ten seconds per cycle, i.e. five seconds of breathing in and five seconds of breathing out. Maximum cardiac coherence may then be obtained when a frequency of six respiratory cycles per minute is reached.

The backrest 2 may particularly comprise paddings adapted to improve the comfort of the person P and to maintain him in the armchair. In particular, the backrest 2 may be modelled so as to guarantee the positioning of the vertebral column of the person P opposite the pressure application device 3 of the person P. For example, a medium density foam (around 35 kg/m³) and potentially an additional foam of lower density (around 20 to 25 kg/m³) may be applied over substantially the whole reception face of the backrest 2. An additional strip of foam may moreover be applied in the backrest 2, at the level of the surface of application of the pressure application device 3.

The backrest 2 preferably comprises a covering that is biocompatible and resistant to cleaning agents.

In a form of embodiment, the system 1 may further comprise a seat 24, which forms an angle with the backrest 2 and extends from its lower part 20, in order to receive the lower extremities of the person P and form an armchair. The seat 24 is however optional.

The pressure application device 3 is configured to apply pressure against the backrest 2, between the lower part 20 of the backrest 2 and its upper part 22, in order to arch the part of the back extending opposite his thorax, which makes it possible to increase the amplitude of the movement of his diaphragm and to improve his oxygenation, in particular when the person P is in breathing in phase. The pressure application device 3 may particularly be guided by computer in order to apply mechanised supports on a precise zone of the body of the person, preferably the most physiologically suited zone.

To this end, the pressure application device 3 may particularly comprise at least two coaxial rollers 30 configured to apply pressure on either side of the vertebral column of the person P. In the example of embodiment illustrated in the figures, the pressure application device 3 comprises two groups of four rollers 30. Each group of rollers is rotationally moveable mounted around a corresponding axis 32. The two corresponding axes 32 extend in parallel, as illustrated in FIG. 3.

The rollers 30 may particularly have the shape of a castor, rotationally mounted around the axis 32.

Hereafter, the invention will be more particularly described in the case where the pressure application device 3 comprises rollers 30. This is not however limiting, sliding rolls could for example be implemented instead of rollers 30.

The rollers 30 are mounted on the actuator and are moved by the actuator between the lower part 20 and the upper part 22 of the backrest 2 in order to apply pressure against the backrest 2 on either side of the vertebral column of the person P and to arch the back of the person P to progressively open his rib cage and favour deep oxygenation.

To this end, the bending assembly 42 may for example comprise a jack 44 comprising a cylinder 46 and a rod 45, and a plate 48, comprising a first zone 48a and a second zone 48b, the first zone 48a being connected to the rod 45 of the jack 44 through a first pivot link 49a and the second zone 48b being connected to the cylinder 46 of the jack 44 through a second pivot link 49b.

Preferably, the plate 48 is rigid so that the first zone 48a and the second zone 48b are fixed with respect to each other and separate at all times.

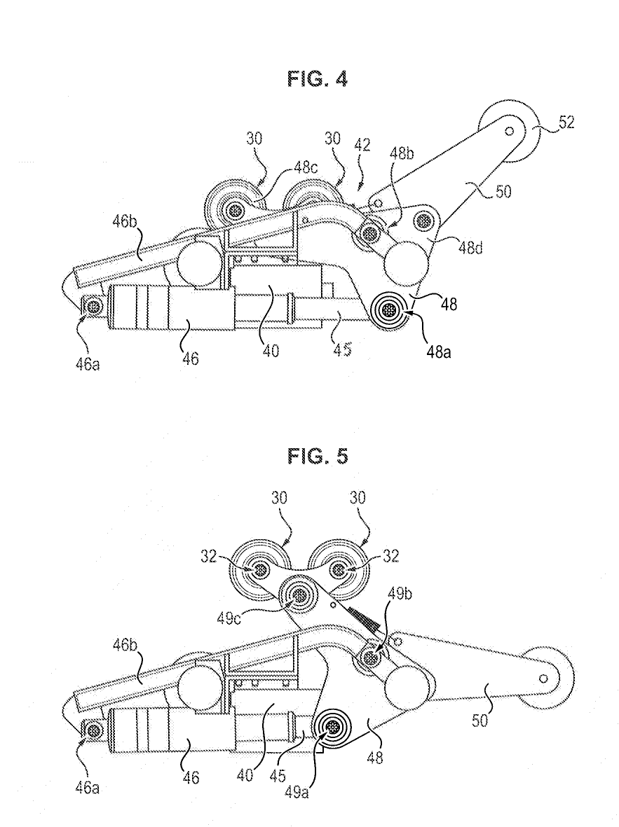

The rollers 30 are connected to the actuator through the plate 48, preferably at the level of a third zone 48c separate from the first and the second zones 48b of the plate 48, through a third pivot link 49c. This configuration of the actuator makes it possible to modulate the sinking in of the rollers 30 into the backrest 2, and thus the curvature of the back of the person P. Thus, in the example illustrated in the figures:
the first pivot link 49a extends to the level of the free end of the rod 45 of the jack 44. The actuation of the jack 44 thus has the effect of translating the first pivot link 49a along the axis of the jack 44 (see FIGS. 4 and 5),
a rigid arm 46b extends between the closed end 46a of the cylinder 46 of the jack 44 and the second zone 48b of the plate 48. The trajectory of the second zone 48b of the plate 48 is thus a circle (in the frame of reference of the bending assembly 42) of which the radius corresponds to the distance between the closed end 46a of the cylinder 46 of the jack 44 and the second pivot link 49b,
the third pivot link 49c extends between the closed end 46a of the cylinder 46 of the jack 44 and the second pivot link 49b. The actuation of the jack and the translation of the first pivot link 49a thus has the effect of making the plate 48 pivot around the first and the second pivot links 49b, and thus of moving the rollers 30, either in the direction of the backrest 2 in their active configuration (when the rod 45 of the jack 44 is retracted into the cylinder 46), or moving away from the backrest 2 in their passive configuration (when the rod 45 of the jack 44 is out of the cylinder 46). The third pivot link 49c, between the rollers 30 and the plate 48, then makes it possible to apply the two sets of rollers 30 against the backrest 2 in a homogenous manner, whatever the orientation of the lower face of said backrest 2.

The guiding assembly 40 for its part may comprise a carriage 40, translationally moveable along the backrest 2 between the lower position and the upper position of the backrest 2. The plate 48 and the cylinder 46 of the jack 44 of the bending assembly 42 may then be fixed on the carriage 40 and moved between the lower part 20 and the upper part 22 of the backrest 2 in order to arch progressively the back of the person P.

In a form of embodiment, the travel of the carriage 40 may be predetermined, independently of the size and the morphology of the person P.

In a variant, the travel of the carriage 40 may be adjusted as a function of the morphology of the person P in order to move the rollers 30 between a lower position 21, extending substantially opposite the lower part of the abdomen D1 of the person P when he is positioned in the backrest 2 (i.e. at around five centimetres under the belly button of the person P), and an upper position 23, extending near to the start of the large dorsal muscle D2 of the person P. Depending on the morphology of the person P, the travel of the carriage 40 may for example be comprised between 200 mm and 300 mm. The carriage 40 may moreover move at a speed of the order of 25 to 150 millimetres per second, for example 28.5 millimetres per second.

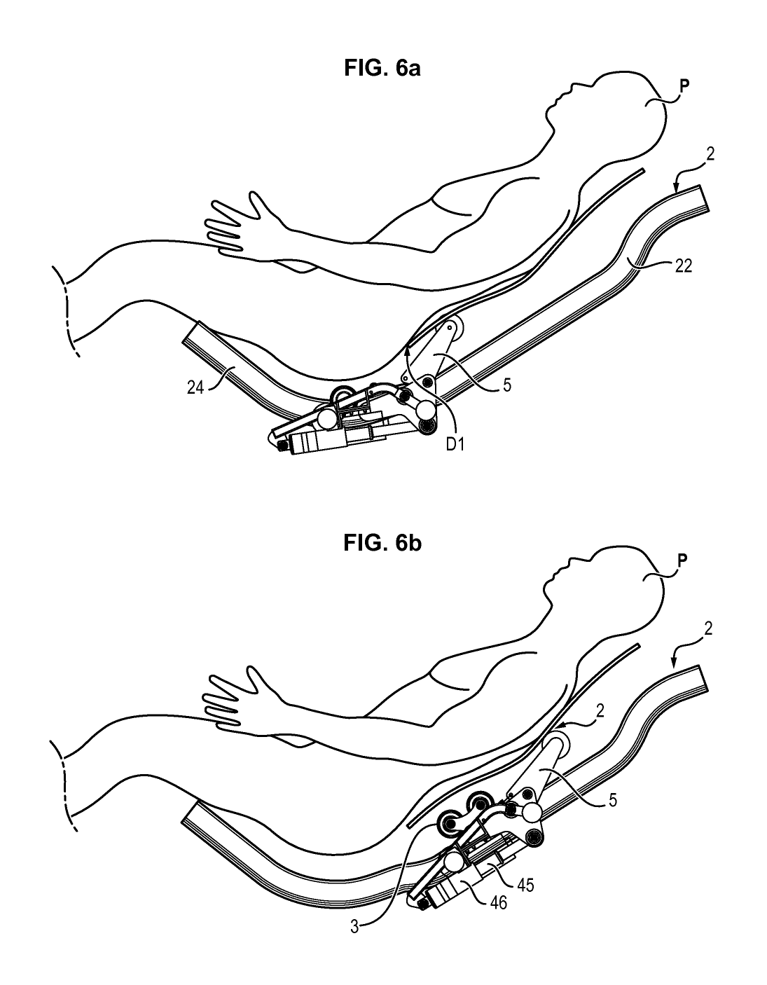

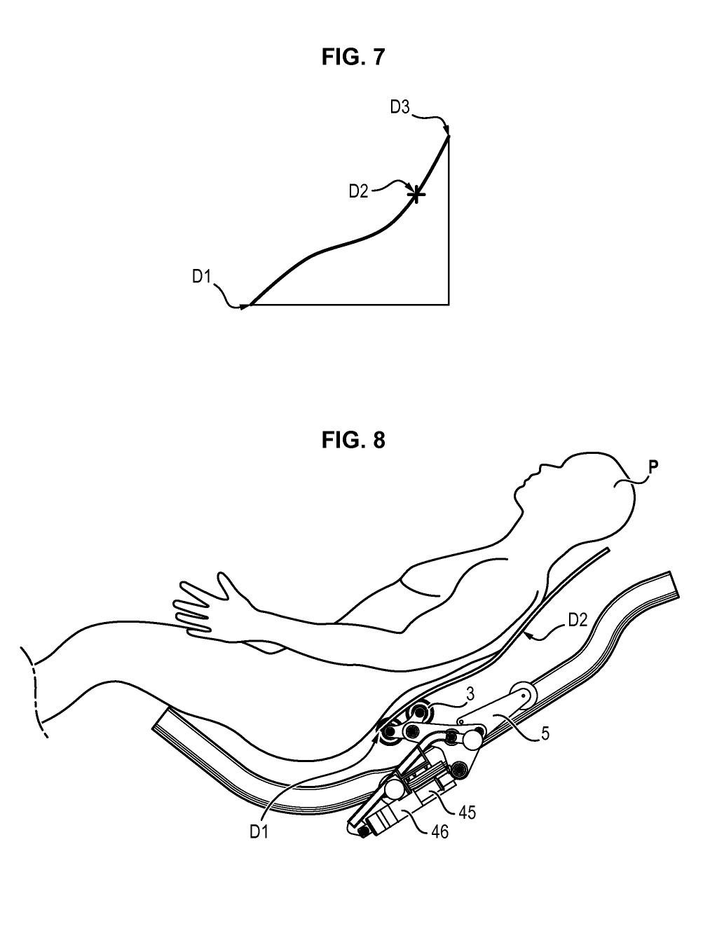

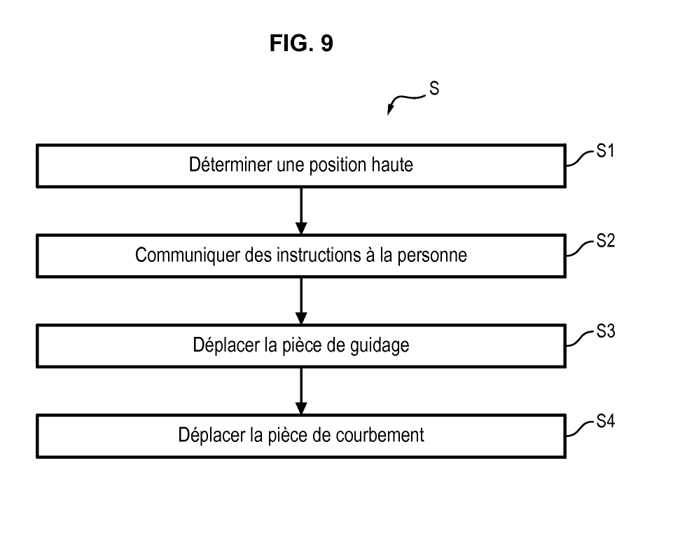

In this embodiment variant, the upper position 23 may be determined by means of a scanning device 5, applied against the backrest 2 when the person P is leaning against the backrest 2. For example, the scanning device 5 may be configured to apply a strain against the backrest 2 and determine a breaking of the strain corresponding to the upper limit of the back at the level of the shoulders (position D2 in FIG. 6b). It is then possible, by locating the position of this breaking point, to identify the upper position 23 for this person P (see the profile between the points D2, which corresponds to the upper position 23, and the point D3, which corresponds to the end of travel of the scanning device 5, in appended FIG. 7). The lower position 21 for its part may be predetermined and fixed (position D1 in FIG. 6a), the variations of the lower position in persons P and their influence on accompanying and making rhythmical respiration being negligible.

The scanning device 5 may for example be fixedly mounted on a fourth zone 48d of the plate 48. In the example of embodiment illustrated in the figures, the fourth zone 48d extends opposite to the third zone 48c with respect to the second zone 48b of the plate 48. The scanning device 5 is preferably oriented with respect to the plate 48 so that said device 5 only comes into contact with the backrest 2 when the rollers 30 extend at a distance therefrom, and vice-versa.

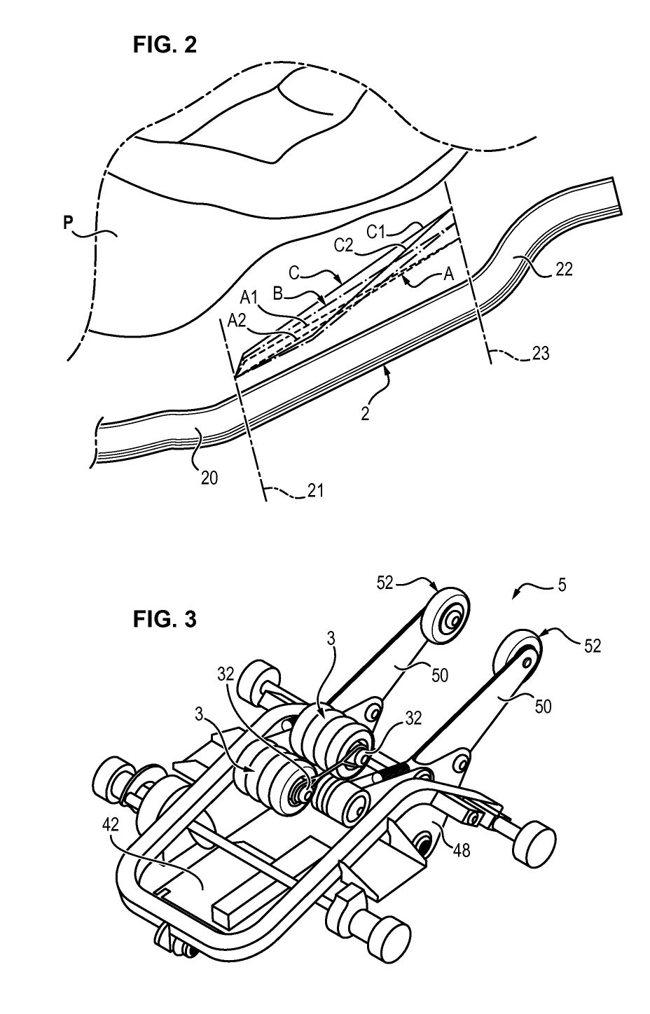

An example of embodiment of such a scanning device 5 is illustrated in FIGS. 2 to 4. Here, the scanning device 5 comprises an arm 50, fixedly mounted on the fourth zone 48d of the plate 48 and equipped at the level of a free end with a castor 52. The outlet of the rod 45 of the jack 44 (FIG. 4) has the effect of bringing the rollers 30 into passive configuration (retracted) and to apply the castor 52 of the scanning device 5 into the backrest 2. The carriage 40 may then be moved from the lower part 20 to the upper part 22 of the backrest 2, until the breaking point due to the presence of the shoulders of the person P against the backrest 2 is detected. The scanning device 5 may then be retracted (FIG. 5).

The system 1 may further comprise a tipping device 6, configured to rock the system 1 from front to back as a function of the position of the guiding assembly 40, in order to improve the circulation of fluids (air, blood, etc.) in the body of the person P and thus to improve his wellbeing. More precisely, this option may be incorporated in the system and thus make it possible to rock the person backwards to the rhythm of breathing in and forwards to breathing out. The inclination and the rocking of the system then favours better circulation of blood and fluids leading to a regeneration of all of the organs as well as deep detoxination and consequently a total relief of the person P.

Method S for Accompanying

During a first step, the person P leans against the backrest 2. When the system 1 comprises a seat 24, it suffices to achieve this that the person P sits down on the seat 24 and leans against the backrest 2, in a comfortable relaxed position.

During a second step S1, optional, the lower position 21 and the upper position 23 of travel of the guiding assembly 40 are determined.

In the example of embodiment illustrated in FIGS. 4, 6a and 6b, the rod 45 of the jack 44 is for example retracted in order to bring the scanning device 5 against the backrest 2 and to retract into passive configuration the rollers 30, then the guiding assembly 40 may be moved from the lower part 20 (FIG. 6a) of the backrest 2 to its upper part 22 (FIG. 6b), in order to determine the zone of the backrest 2 against which is pressing the start of the large dorsal muscle D2 of the person P.

The backrest 2 may then be placed so that the person P is in the so-called “zero gravity” position, which corresponds to a position of maximum comfort making it possible to improve the opening of the rib cage and thus the respiratory exercise. Reference may in particular be made to the application CN 20177575 for more details on the “zero-gravity” position.

During a third step S3, S4, the rollers 30 are moved between the lower part 20 and the upper part 22 of the backrest 2, up to the upper position 23. During this movement, the rollers 30 are moreover moved along an axis substantially perpendicular to a direction of movement X of the guiding assembly 40 (that is to say substantially perpendicularly to the backrest 2), between their active configuration and their passive configuration.

Preferably, the rollers 30 are brought into passive configuration when the guiding assembly 40 is moved from the upper part 22 to the lower part 20 of the backrest 2 (either suddenly as soon as the rollers 30 change direction, or progressively according to a kinematic making it possible to progressively bring the back of the person P into initial position) and in active configuration when the guiding assembly 40 is moved from the lower part 20 to the upper part 22 of the backrest 2. In this way, the system 1 assists the person P during breathing in phases by deploying his rib cage while allowing the person P to sink slightly by gravity into the backrest 2 during breathing out phases, his back not being or being little stressed by the rollers 30, which favours a more complete and deep respiration of the person P.

Moreover, in active configuration (FIG. 8), the rollers 30 may be sunk progressively into the backrest 2 between the lower part 20 and the upper part 22 of the backrest 2 in order to arch progressively the back of the person P. In a form of embodiment, the sinking in of the rollers 30 into the back may be progressive and substantially linear between the lower part 20 of the backrest 2 and the upper part 22. In a variant, the sinking in may be variable, while being greater near to the upper part 22 of the chair than in the lower part 20 thereof.

Examples of trajectories of the rollers 30 have been illustrated in FIG. 2. For example, the trajectories referenced A correspond to a gentle movement of the back of the person P. The profile A1 of the trajectory A comprises a first part corresponding to a rapid movement of the rollers 30 in the lower part 20 of the backrest 2, in order to signal to the person P the start of the exercise, then a second part corresponding to a progressive movement of the rollers 30 in order to arch progressively, with a small amplitude, the back of the person P. The profile C2 for its part corresponds to the return of the rollers 30 to the lower part 20 and comprises a progressive retraction of the rollers 30 until the passive configuration is reached.

The trajectories B and C correspond respectively to a moderate movement and to a large movement of the back of the person P. Thus, the profile C1 of the trajectory C corresponds to the movement of the rollers 30 between the lower part 20 and the upper part 22 and comprises a first part corresponding to a rapid movement of the rollers 30 in the lower part 20 of the backrest 2 to signal the start of the exercise followed by a second part corresponding to a progressive movement of the rollers 30 in order to arch progressively, with a large amplitude, the back of the person P. The profile C2 for its part corresponds to the return of the rollers 30 to the lower part 20 and comprises a first part corresponding to a progressive retraction of the rollers 30 until the back of the person P comes to sink into the backrest 2 under the effect of gravity, followed by a second part in which the rollers 30 are in passive configuration.

Preferably, the person P breathes in when the rollers 30 are moved by the guiding assembly 40 from the lower part 20 to the upper part 22, and breathes out when the rollers 30 are in passive configuration and brought back to the lower part 20 of the backrest 2. If need be, instructions may be communicated to the person P in order to synchronise his respiration with the movement of the rollers 30. In a variant, the moment where the person P feels that the rollers 30 are brought into their active configuration can serve as a signal to the person P to begin breathing in and to synchronise himself with the system 1 for accompanying.

Such synchronisation of respiration with the movement of the rollers 30 makes it possible to rhythm the respiration of the person, to open his rib cage when the person P is in breathing in phase and thus to improve his oxygenation, thanks to the curvature conferred by the movement of the rollers 30 to the back of the person P.

In a form of embodiment, instructions may be communicated to the person P in order to help him to synchronise his respiration (breathing in and breathing out phases) with the movement of the rollers 30. These instructions may be given by an operator, present during the use of the system for accompanying 1, or in a variant by a control unit, connected to the actuator. The control unit 7 may for example comprise a dedicated application on a mobile telephone of the smartphone type, a tablet or a screen connected to a central unit. The instructions may then be displayed on the screen of the control unit 7 and/or transmitted by means of an associated loudspeaker.

If need be, during the movement of the rollers 30 by the guiding assembly 40, the backrest 2 may be rocked back and forth in order to accompany the circulation of fluids within the body of the person P, which favours among other things his blood circulation and his relief. Preferably, the backrest 2 is tipped backwards (upper part 22 brought closer to the ground) in breathing in phase of the person P then forwards in breathing out phase.

The invention thus makes it possible to sensitise and guide the person P towards deeper and slower respiration to provide benefits to the body and to the mind. The system 1 and the associated method make it possible in fact to enable the person P to properly understand the respiratory phenomenon, to control it and to master it. By being really responsive to him, the person P may, thanks to very simple and very easy exercises, avoid or correct numerous problems linked to incomplete or blocked respiration, harmful to his wellbeing and to his ability to manage stress.

If need be, the system 1 for accompanying may also comprise at least one of the following devices:
a pulse taking device,
a system 1 for heating the backrest 2, in order to improve the physical wellbeing of the person P,
a respiratory system 1, configured to increase the supply of oxygen to the person P (typically up to 30%). For example, it may be an extra-buccal mouthpiece connected to an oxygen source and being able to be positioned opposite the nose or the mouth of the person P. This supply of oxygen brings comfort and relaxation to the person P and may particularly be beneficial in polluted environments or in preparation for a sporting event,
a lighting system 1 of the LED (acronym for light emitting diode) type, synchronised with the method S for accompanying and being able for example to be configured to light up the backrest 2 or any other part of the system 1 for accompanying as a function of the phases of the exercise. For example, the LED may change colour several minutes before the end of the exercise in order to signal to an operator this end of exercise.

1. System for accompanying (1) the respiration of a person (P), comprising:
a backrest (2) configured to support the back of a person (P) and comprising a lower part (20) and an upper part (22) intended to come opposite a lower part and an upper part, respectively, of the back of the person (P),
a pressure application device (3), configured to apply pressure against the backrest (2), and
an actuator comprising:
a guiding assembly (40) configured to move the pressure application device (3) between the lower part (20) and the upper part (22) of the backrest (2), and
a bending assembly (42), configured to sink progressively into the backrest (2), during the movement of the guiding assembly (40) between the lower part and the upper part of the backrest (2), the pressure application device (3) following an axis substantially perpendicular to a direction of movement (X) of the guiding assembly (40) between a passive configuration, in which the pressure application device (3) is retracted and an active configuration, in which the pressure application device is sunk into the backrest (2).

2. System for accompanying (1) according to claim 1, in which the bending assembly (42) comprises:
a jack (44) comprising a cylinder (46) and a rod (45), and
a plate (48) comprising a first zone (48a) and a second zone (48b), the first zone (48a) being connected to the rod (45) of the jack (44) through a first pivot link (49a) and the second zone (48b) being connected to the cylinder (46) of the jack (44) through a second pivot link (49b),
the pressure application device (3) being connected to the bending assembly (42) through the plate (48).

3. System for accompanying (1) according to claim 2, in which, the first zone (48a) and the second zone (48b) are separate and fixed with respect to each other.

4. System for accompanying (1) according to claim 2, in which the pressure application device (3) is connected to the plate (48) through a third pivot link (49c), separate from the first and the second pivot links (49a, 49b).

5. System for accompanying (1) according to claim 1, in which the guiding assembly (40) comprises a carriage, translationally moveable along the backrest (2) between the lower position and the upper position of said backrest (2), the bending assembly (42) being fixed onto said carriage (40).

6. System for accompanying (1) according to claim 1, in which the pressure application device (3) comprises at least two coaxial rollers (30) configured to apply pressure on either side of the vertebral column of the person (P).

7. System for accompanying (1) according to claim 1, further comprising a scanning device (5) configured to determine a maximum travel of the guiding assembly (40) between the lower part (20) and the upper part (22) of the backrest (2).

8. System for accompanying (1) according to claim 7, further comprising a tipping device (6), configured to rock the system for accompanying (1) as a function of the position of the guiding assembly (40).

9. System for accompanying (1) according to claim 1, further comprising a control unit (7) configured to communicate instructions to the person (P) as a function of the position of the guiding assembly (40), said control unit (7) being able to comprise a telephone, a tablet or a central unit connected to a screen.

10. Method for accompanying (S) the respiration of a person (P) by means of a system for accompanying (1), said system for accompanying comprising:
a backrest (2) configured to support the back of a person (P) and comprising a lower part (20) and an upper part (22) intended to come opposite a lower part and an upper part, respectively, of the back of the person (P),
a pressure application device (3), configured to apply pressure against the backrest (2), and
an actuator comprising
a guiding assembly (40) configured to move the pressure application device (3) between the lower part (20) and the upper part (22) of the backrest (2), and
a bending assembly (42), configured to sink progressively into the backrest (2), during the movement of the guiding assembly (40) between the lower part and the upper part of the backrest (2), the pressure application device (3) following an axis substantially perpendicular to a direction of movement (X) of the guiding assembly (40) between a passive configuration, in which the pressure application device (3) is retracted and an active configuration, in which the pressure application device (3) is sunk into the backrest (2),
the method for accompanying comprising the following steps:
moving (S3) the guiding assembly (40) in order to move the pressure application device (3) between the lower part (20) and the upper part (22) of the backrest (2) and,
simultaneously, moving (S4) progressively the bending assembly (42) along an axis substantially perpendicular to a direction of movement (X) of the guiding assembly (40) between a passive configuration, in which the pressure application device is retracted and an active configuration, in which the pressure application device is sunk into the backrest.

11. Method for accompanying (S) according to claim 10, in which the pressure application device (3) is brought progressively into passive configuration when the guiding assembly (40) is moved (S3) from the upper part (22) in the direction of the lower part (20) of the backrest (2) and is brought into active configuration when the guiding assembly (40) is moved (S3) from the lower part (20) in the direction of the upper part (22) of the backrest (2).

12. Method for accompanying (S) according to claim 10, in which in active configuration, the pressure application device (3) is sunk (S4) progressively into the backrest (2) from the lower part (20) to the upper part (22).

13. Method for accompanying (S) according to claim 12, in which the sinking in (S4) of the pressure application device (3) is linear.

14. Method for accompanying (S) according to claim 12, in which the sinking in (S4) of the pressure application device (3) is variable as a function of the position of the pressure application device (3), the pressure application device (3) being sunk more into the backrest (2) near to the upper part (22) of said backrest (2) than near to its lower part (20) in order to improve the curvature of the back of the person (P).

15. Method for accompanying (S) according to claim 10, further comprising a step during which instructions are communicated (S2) to the person (P) in order to synchronise the respiration of said person (P) with the movement of the pressure application device (3).

16. Method for accompanying (S) according to claim 10, further comprising the rocking of the system for accompanying (1) as a function of the movement of the guiding assembly (40).
